(19) United States
(12) Patent Application Publication
(10) Pub. No.: US 2014/0366434 A1
(43) Pub. Date: Dec. 18, 2014

(54) APPARATUS AND METHOD FOR MANAGING CROP GROWTH

(71) Applicant: Electronics and Telecommunications Research Institute, Daejeon (KR)

(72) Inventors: Kyu-Hyung KIM, Daegu (KR); Ae-Kyeung MOON, Daegu (KR)

(21) Appl. No.: 14/304,423

(22) Filed: Jun. 13, 2014

(30) Foreign Application Priority Data
Jun. 14, 2013 (KR) 10-2013-0068356

(51) Int. Cl. A01G 1/00

(52) U.S. Cl. CPC A01G 1/001
USPC 47/17

(57) ABSTRACT

Disclosed herein are an apparatus and method for managing the growth of crops by individually monitoring the growth state of crops produced in a greenhouse or plant factory. The crop growth management apparatus includes a weight measurement unit configured to measure the weight of a crop that is being grown using the tension of a support string connected to the crop, a crop growth and development management unit configured to determine whether or not the growth and development state of the crop or the weight of the crop is proper based on the measured weight of the crop, and an environment control unit configured to locally control a crop cultivation environment based on a result of the determination regarding whether or not the growth and development state of the crop or the weight of the crop is proper.

### CROSS-REFERENCE TO RELATED APPLICATION

This application claims the benefit of Korean Patent Application No. 10-2013-0068356, filed on Jun. 14, 2013, which is hereby incorporated by reference in its entirety into this application.

### BACKGROUND OF THE INVENTION

1. Field of the Invention

The present invention relates to a crop growth management apparatus and method and, more particularly, to an apparatus and method for managing the growth of crops by individually monitoring the growth state of crops produced in a greenhouse or plant factory and locally controlling a cultivation environment based on a result of the monitoring.

2. Description of the Related Art

In current crop fields, in order to manage the growth state of crops cultivated in greenhouses and plant factories, the state of crops that are grown, that is, grown crops, is monitored and environment control is performed in order to take measures suitable for a result of the monitoring.

A method of monitoring the state of grown crops as described above includes a method of directly checking, by a person, the state of grown crops, a method of obtaining an image of grown crops using a weight sensor or a camera and checking the growth state of the crops based on the obtained image of the crops, and so on.

For example, Korean Patent Application No. 2013-0035809 entitled “The Area an Output Measurement and Management System Using Weight Measurement Sensor” describes technology capable of managing and predicting daily and monthly yields by checking the position of an area using wireless communication and monitoring the weight of farm products measured by a weight measurement sensor.

However, the number of crops that are cultivated in each area may be different due to the nature of a greenhouse and plant factory, and it is difficult to put a crop growth management method using a weight sensor or a camera to practical use owing to various factors, such as that crops embower each other and light environments minute by minute. For this reason, in reality, a person directly manages the state of grown crops daily.

### SUMMARY OF THE INVENTION

An object of the present invention is to provide an apparatus and method for managing the growth of crops by individually monitoring the growth state of crops produced in a greenhouse or plant factory and locally controlling a cultivation environment based on a result of the monitoring.

Technical objects to be achieved by the present invention are not limited to the above-described objects and other technical objects that have not been described will be evidently understood by those skilled in the art from the following description.

In accordance with an aspect of the present invention, a crop growth management method includes measuring the weight of a crop that is being grown using the tension of a support string connected to the crop, comparing the measured weight of the crop with a proper crop weight corresponding to time when the weight of the crop is measured and determining whether or not the growth and development state of the crop is proper based on a result of the comparison, comparing the measured weight of the crop with the mean weight of crops within a greenhouse in which the crop having the measured weight is placed and determining whether or not the measured weight of the crop is proper based on a result of the comparison, and managing the growth of the crop by locally controlling a crop cultivation environment based on the growth and development state of the crop or a result of the determination regarding whether or not the weight of the crop is proper.

The proper crop weight may include weight information corresponding to the growth and development degree of the crop according to an environment and time in which the weight of the crop is measured after the crop is sown.

Managing the growth of the crop by locally controlling the crop cultivation environment may include controlling the crop cultivation environment using one of artificial lighting, a nutrient solution, and watering corresponding to the crop.

Measuring the weight of the crop and managing the growth of the crop may be performed in different networks or in an identical network.

A network used for the determining may be different from networks used to measure the weight of the crop and to manage the growth of the crop.

In accordance with another aspect of the present invention, a crop growth management apparatus includes a weight measurement unit configured to measure the weight of a crop that is being grown using the tension of a support string connected to the crop, a crop growth and development management unit configured to determine whether or not the growth and development state of the crop or the weight of the crop is proper based on the measured weight of the crop, and an environment control unit configured to locally control a crop cultivation environment based on a result of the determination of the crop growth and development management unit regarding whether or not the growth and development state of the crop or the weight of the crop is proper.

The crop growth and development management unit compares the measured weight of the crop with a proper crop weight corresponding to time when the weight of the crop is measured and determines whether or not the growth and development state of the crop is proper based on a result of the comparison.

The proper crop weight may include weight information corresponding to the growth and development degree of the crop according to an environment and time in which the weight of the crop is measured after the crop is sown.

The crop growth and development management unit compares the measured weight of the crop with the mean weight of crops within a greenhouse in which the crop having the measured weight is placed and determines whether or not the measured weight of the crop is proper based on a result of the comparison.

The environment control unit controls the crop cultivation environment using one of artificial lighting, a nutrient solution, and watering corresponding to the crop.

The grown crop may be cultivated using a gentle cultivation method or an induction string cultivation method.

The crop growth and development management unit may locally control the crop cultivation environment using a network different from networks in which the weight measurement unit and the environment control unit are included.

### BRIEF DESCRIPTION OF THE DRAWINGS

The above and other objects, features and advantages of the present invention will be more clearly understoon from the following detailed description taken in conjunction with the accompanying drawings, in which:

FIG. 1 is a diagram showing a bed that is applied to common crop cultivation.

FIG. 2 is a reference diagram showing a case where a gentle cultivation method has been applied to an actual cultivation site in accordance with an embodiment of the present invention.

FIG. 3 is a reference diagram showing a case where an induction string cultivation method has been applied to an actual cultivation site in accordance with an embodiment of the present invention.

FIG. 4 is a diagram schematically showing a crop growth management apparatus in accordance with an embodiment of the present invention.

FIG. 5 is a diagram showing a data transmission environment applied to the crop growth management apparatus in accordance with an embodiment of the present invention.

FIG. 6 is a flowchart illustrating a method of quantizing the weakness of a system in accordance with an embodiment of the present invention.

FIG. 7 is an embodiment of the present invention implemented in a computer system.

### DESCRIPTION OF THE PREFERRED EMBODIMENTS

Hereafter, the present invention is described in detail with reference to the accompanying drawings. Repeated descriptions and descriptions of known functions and constructions which are deemed to make the gist of the present invention unnecessarily vague are omitted below. The embodiments of the present invention are provided in order to fully describe the present invention to those skilled in the art. Accordingly, the shapes, sizes, etc. of elements in the drawings may be enlarged for clarity of description.

An apparatus and method for managing crop growth in accordance with exemplary embodiments of the present invention are described in detail below with reference to the accompanying drawings.

First, a cultivation method which is commonly used in a greenhouse, for example, a plastic greenhouse or a glass greenhouse is described below.

In general, a gentle cultivation method is chiefly used to cultivate strawberries. In the gentle cultivation method, strawberries are cultivated so that the stems of the strawberries are grown toward the ground. Accordingly, the gentle cultivation method is recently used a lot because strawberries are well grown and the harvest of strawberries is convenient.

A lead-in string (or induction string) cultivation method is commonly used to increase the yield of crops having great height, such as paprika or tomatoes.

In such a gentle cultivation method or lead-in string (or induction string) cultivation method, grown crops form the woods as the grown crops grow. This makes it difficult to monitor a crop growth process using images, and as a result, a person has to directly monitor a crop growth process.

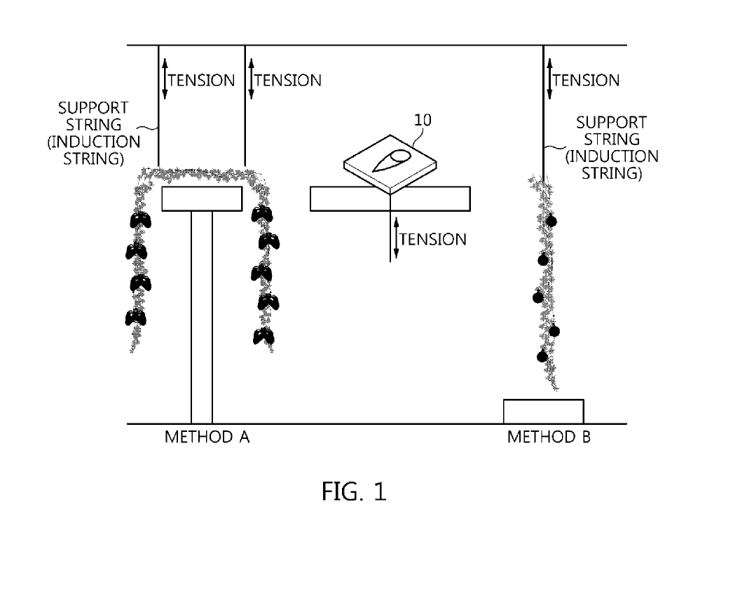

A bed applied to common crop cultivation is described in detail below with reference to FIG. 1.

FIG. 1 is a diagram showing a bed that is applied to common crop cultivation. Referring to FIG. 1, in both the gentle cultivation method (i.e., a method A of FIG. 1) and the lead-in string (or induction string) cultivation method (i.e., a method B of FIG. 1), a support string (or induction string) may be used to support a crop and is normally used to only support a crop.

A known grown crop weight measurement and transmission device 10 functions to measure the weight of a crop using a support string (or induction string) on a specific time and send the measured results. To this end, the grown crop weight measurement and transmission device 10 includes a sensor capable of measuring the weight of a crop and has a function for sending the measured weight.

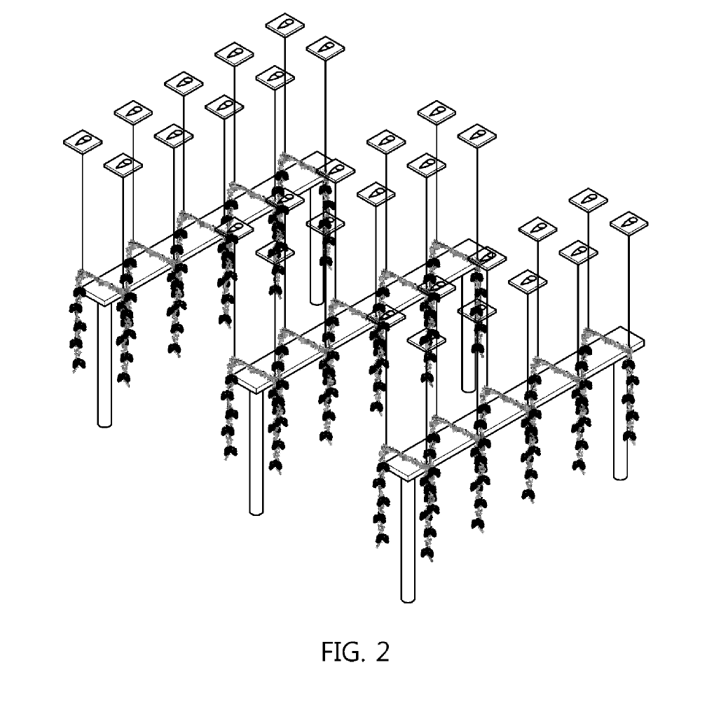

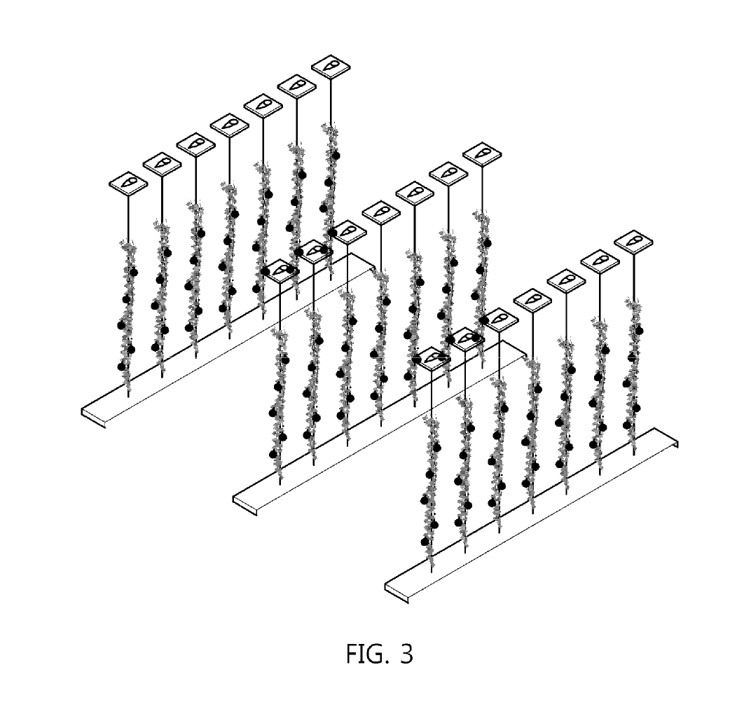

A case where the bed applied to crop cultivation shown in FIG. 1 is applied to an actual cultivation site is shown in FIGS. 2 and 3.

FIG. 2 is a reference diagram showing a case where the gentle cultivation method has been applied to an actual cultivation site in accordance with an embodiment of the present invention. Furthermore, FIG. 3 is a reference diagram showing a case where the lead-in string (or induction string) cultivation method has been applied to an actual cultivation site in accordance with an embodiment of the present invention.

Referring to FIGS. 2 and 3, a plurality of the grown crop weight measurement and transmission devices 10 is necessary in an actual cultivation site, which results in high-capacity data transmission traffic.

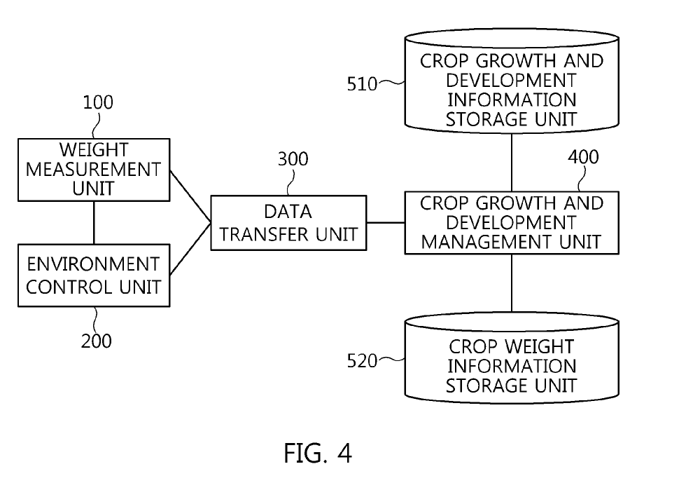

Accordingly, for efficient data transmission, a crop growth management apparatus in accordance with an embodiment of the present invention is described in detail below with reference to FIG. 4.

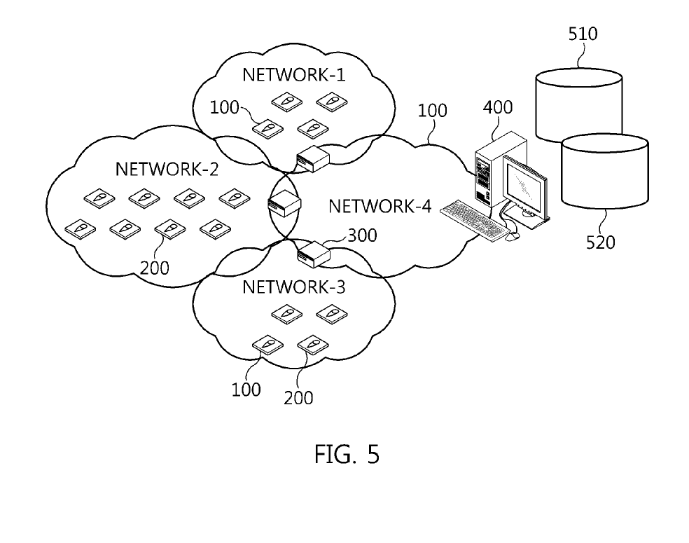

FIG. 4 is a diagram schematically showing the crop growth management apparatus in accordance with an embodiment of the present invention. Furthermore, FIG. 5 is a diagram showing a data transmission environment applied to the crop growth management apparatus in accordance with an embodiment of the present invention.

Referring to FIG. 4, the crop growth management apparatus includes a weight measurement unit 100, an environment control unit 200, a data transfer unit 300, a crop growth and development management unit 400, a crop growth and development information storage unit 510, and a crop weight information storage unit 520.

A data transmission environment to which the crop growth management apparatus is applied in accordance with an embodiment of the present invention may include, as shown in FIG. 5, a network NETWORK-1 including only a plurality of the weight measurement units 100, a network NETWORK-2 including only a plurality of the environment control units 200, a network NETWORK-3 including the weight measurement units 100 and the environment control units 200, and a network NETWORK-4 including the data transfer unit 300 and the crop growth and development management unit 400.

The weight measurement unit 100 measures the weight of a grown crop using the tension of a support string (or induction string) every time that has been previously set. Here, the support string (or induction string) is a string connected to a grown crop and may be used to support the grown crop and also to measure the weight of the grown crop. Furthermore, the weight measurement unit 100 may include a sensor capable of measuring the weight of a grown crop. The weight measurement unit 100 transfers the measured weight of the grown crop to the data transfer unit 300 that is placed in a network in which the corresponding weight measurement unit 100 is placed.

The environment control unit 200 locally controls the cultivation environment of a grown crop and controls the cultivation environment of a specific area. The cultivation environment may be a cultivation environment to which artificial lighting, a nutrient solution, and watering are applied, but the present invention is not limited thereto. In other words, the environment control unit 200 controls a cultivation environment using artificial lighting, a nutrient solution, and watering that affect the growth and development or the weight of a crop.

The environment control unit 200 receives an environment control instruction from the data transfer unit 300 and performs local environment control in response to the received environment control instruction.

The data transfer unit 300 transfers the weight of a crop, received from the weight measurement unit 100, to the crop growth and development management unit 400 or transfers an environment control instruction, generated by the crop growth and development management unit 400 based on the weight of a crop, to the environment control unit 200.

To this end, the data transfer unit 300 is placed in a network in which the weight measurement units 100 or the environment control units 200 are included.

The crop growth and development management unit 400 collects the weight of a crop received through the data transfer unit 300 and generates an environment control instruction based on the collected weight of the grown crop.

More particularly, the crop growth and development management unit 400 operates in conjunction with the crop growth and development information storage unit 510 and the crop weight information storage unit 520. In FIG. 4, the crop growth and development management unit 400 has been illustrated as operating in conjunction with the crop growth and development information storage unit 510 and the crop weight information storage unit 520, but the crop growth and development management unit 400 may be configured to include the crop growth and development information storage unit 510 and the crop weight information storage unit 520.

The crop growth and development information storage unit 510 includes information about the weight (hereinafter also called weight information) of a grown crop corresponding to the growth and development degree of the grown crop according to an environment and time after the grown crop is sown. Furthermore, the crop weight information storage unit 520 includes the weight of a grown crop measured by the weight measurement unit 100.

The crop growth and development management unit 400 compares information about the weight of a grown crop according to a time/environment, stored in the crop growth and development information storage unit 510, with information about the real-time weight of the grown crop that is stored in the crop weight information storage unit 520 and generates an environment control instruction that locally controls the cultivation environment of the grown crop based on a result of the comparison.

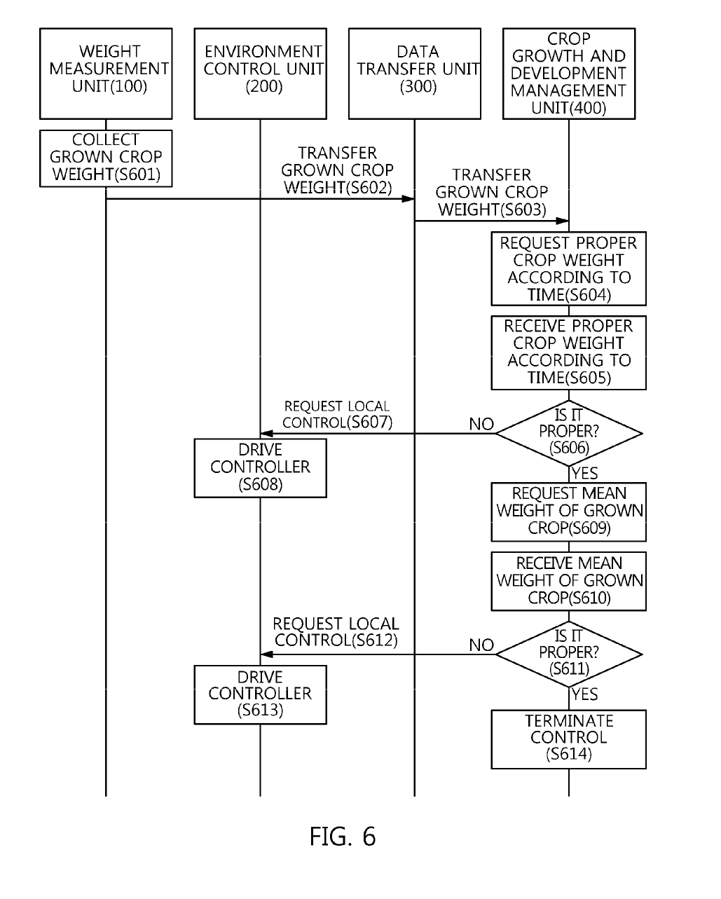

A crop growth management method is described in detail below with reference to FIG. 6.

FIG. 6 is a flowchart illustrating a method of quantizing the weakness of a system in accordance with an embodiment of the present invention.

First, the crop growth management apparatus includes the weight measurement unit 100, the environment control unit 200, the data transfer unit 300, the crop growth and development management unit 400, the crop growth and development information storage unit 510, and the crop weight information storage unit 520 as shown in FIG. 4.

Referring to FIG. 6, the weight measurement unit 100 measures the weight of a crop that is grown using the tension of a support string (or induction string) on a set time and collects the measured weight at step S601. Here, the support string (or induction string) is a string connected to a grown crop and may be used to support the crop and also to measure the weight of the grown crop.

The weight measurement unit 100 transfers the weight of the grown crop, collected at step S601, to the data transfer unit 300 at step S602. Here, the data transfer unit 300 is placed in a network in which the weight measurement unit 100 is included.

The data transfer unit 300 transfers the weight of the grown crop, received at step S602, to the crop growth and development management unit 400 at step S603.

The crop growth and development management unit 400 requests the proper weight of the grown crop according to time, corresponding to the weight of the grown crop received at step S603, from the crop growth and development information storage unit 510 at step S604. At step S605, the crop growth and development management unit 400 receives the proper crop weight according to time corresponding to the request at step S604. Here, the proper crop weight is calculated using a total weight of the grown crop (including the leaves, stems, and fruits of the grown crop) and the weight of the grown crop collected on a specific time. The calculated proper crop weight is stored in the crop growth and development information storage unit 510.

The crop growth and development management unit 400 compares the weight of the grown crop, received at step S603, with the proper crop weight received at step S605 and determines whether or not the growth and development state of the grown crop is proper based on a result of the comparison at step S606.

If, as a result of the determination at step S606, it is determined that the growth and development state of the grown crop is not proper, the crop growth and development management unit 400 requests a local control request from the environment control unit 200 at step S607. In response to the request, the environment control unit 200 controls the cultivation environment, for example, the controller of a specific area corresponding to a crop whose growth and development state is not proper so that the cultivation environment operates at step S608.

If, as a result of the determination at step S606, it is determined that the growth and development state of the grown crop is proper, the crop growth and development management unit 400 requests the weight of other grown crops, placed in a greenhouse in which the grown crop having the weight received at step S603 is placed, from the crop weight information storage unit 520 at step S609. At step S610, the crop growth and development management unit 400 receives the mean weight of other grown crops within the greenhouse corresponding to the request at step S609.

The crop growth and development management unit 400 compares the weight of the grown crop, received at step S603, with the mean weight of other grown crops within the greenhouse received at step S610 and determines whether or not the weight of the grown crop received at step S603 is proper at step S611.

If, as a result of the determination at step S611, it is determined that the weight of the grown crop received at step S603 is not proper, the crop growth and development management unit 400 requests local control from the environment control unit 200 at step S612. In response thereto, the environment control unit 200 controls the cultivation environment, for example, the controller of the grown crop so that the controller operates and thus the weight of the grown crop corresponds to the mean weight at step S613.

If, as a result of the determination at step S611, it is determined that the weight of the grown crop received at step S603 is proper, the crop growth and development management unit 400 terminates environment control corresponding to the grown crop at step S614.

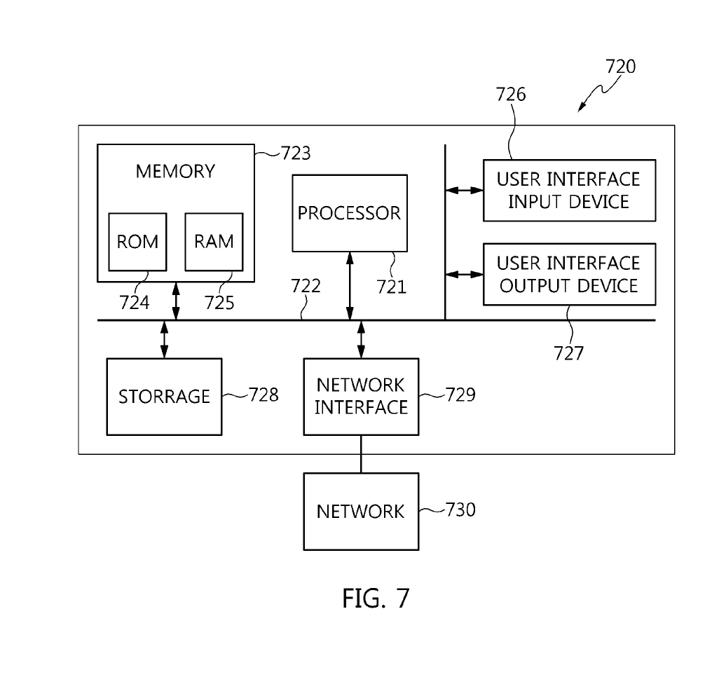

FIG. 7 is an embodiment of the present invention implemented in a computer system.

Refering to FIG. 7, an embodiment of the present invention may be implemented in a computer system, e.g., as a computer readable medium. As shown in in FIG. 7, a computer system 720 may include one or more of a processor 721, a memory 723, a user input device 726, a user output device 727, and a storage 728, each of which communicates through a bus 722. The computer system 720 may also include a network interface 729 that is coupled to a network 730. The processor 721 may be a central processing unit (CPU) or a semiconductor device that executes processing instructions stored in the memory 723 and/or the storage 728. The memory 723 and the storage 728 may include various forms of volatile or non-volatile storage media. For example, the memory may include a read-only memory (ROM) 724 and a random access memory(RAM) 725.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

As described above, according to an embodiment of the present invention, the growth state of crops grown in a greenhouse or plant factory can be individually monitored, local environment control can be performed based on a result of the monitoring, and grown crops can be grown and managed efficiently through such local environment control.

The crop growth management apparatus and method according to the present invention can individually monitor the growth state of crops grown in a greenhouse or plant factory and perform local environment control based on a result of the monitoring. Furthermore, the crop growth management apparatus and method can efficiently manage grown crops through such local environment control.

The exemplary embodiments have been disclosed in the drawings and specification. Specific terms have been used herein, but the terms are used to only describe the present invention, but are not used to limit the meaning of the terms or the scope of the present invention written in the claim. Accordingly, those skilled in the art will understand that various modifications and other equivalent embodiments are possible from the present invention. Accordingly, the true technical scope of the present invention should be determined by the following claims.

What is claimed is:

1. A crop growth management method, comprising:
measuring a weight of a crop that is being grown using a tension of a support string connected to the crop;
comparing the measured weight of the crop with a proper crop weight corresponding to time when a weight of the crop is measured and determining whether or not a growth and development state of the crop is proper based on a result of the comparison;
comparing the measured weight of the crop with a mean weight of crops within a greenhouse in which the crop having the measured weight is placed and determining whether or not the measured weight of the crop is proper based on a result of the comparison; and
managing the growth of the crop by locally controlling a crop cultivation environment based on the growth and development state of the crop or a result of the determination regarding whether or not the weight of the crop is proper.

2. The crop growth management method of claim 1, wherein the proper crop weight comprises weight information corresponding to a growth and development degree of the crop according to an environment and time in which a weight of the crop is measured after the crop is sown.

3. The crop growth management method of claim 1, wherein managing the growth of the crop by locally controlling the crop cultivation environment comprises controlling the crop cultivation environment using one of artificial lighting, a nutrient solution, and watering corresponding to the crop.

4. The crop growth management method of claim 1, wherein measuring the weight of the crop and managing the growth of the crop are performed in different networks or an identical network.

5. The crop growth management method of claim 3, wherein a network used for the determining is different from networks used to measure the weight of the crop and to manage the growth of the crop.

6. A crop growth management apparatus, comprising:
a weight measurement unit configured to measure a weight of a crop that is being grown using a tension of a support string connected to the crop;
a crop growth and development management unit configured to determine whether or not a growth and development state of the crop or a weight of the crop is proper based on the measured weight of the crop; and
an environment control unit configured to locally control a crop cultivation environment based on a result of the determination of the crop growth and development management unit regarding whether or not the growth and development state of the crop or the weight of the crop is proper.

7. The crop growth management apparatus of claim 6, wherein the crop growth and development management unit compares the measured weight of the crop with a proper crop weight corresponding to time when a weight of the crop is measured and determines whether or not the growth and development state of the crop is proper based on a result of the comparison.

8. The crop growth management apparatus of claim 7, wherein the proper crop weight comprises weight information corresponding to a growth and development degree of the crop according to an environment and time in which a weight of the crop is measured after the crop is sown.

9. The crop growth management apparatus of claim 6, wherein the crop growth and development management unit compares the measured weight of the crop with a mean weight of crops within a greenhouse in which the crop having the measured weight is placed and determines whether or not the measured weight of the crop is proper based on a result of the comparison.

10. The crop growth management apparatus of claim 6, wherein the environment control unit controls the crop cultivation environment using one of artificial lighting, a nutrient solution, and watering corresponding to the crop.

11. The crop growth management apparatus of claim 6, wherein the grown crop is cultivated using a gentle cultivation method or an induction string cultivation method.

12. The crop growth management apparatus of claim 6, wherein the crop growth and development management unit locally controls the crop cultivation environment using a network different from networks in which the weight measurement unit and the environment control unit are included.
